(19) United States
(12) Patent Application Publication
(10) Pub. No.: US 2026/0086043 A1
(43) Pub. Date: Mar. 26, 2026

(54) PATTERN INSPECTION APPARATUS AND PATTERN INSPECTION METHOD

(71) Applicant: NuFlare Technology, Inc., Yokohama-shi (JP)

(72) Inventor: Kenta SAGAWA, Yokohama-shi (JP)

(73) Assignee: NuFlare Technology, Inc., Yokohama-shi (JP)

(21) Appl. No.: 19/407,043

(22) Filed: Dec. 3, 2025

Related U.S. Application Data
(63) Continuation of application No. PCT/JP2024/017787, filed on May 14, 2024.

(30) Foreign Application Priority Data
Jun. 9, 2023 (JP) 2023-095655

(51) Int. Cl. G01N 21/956; G01N 21/88; G06T 7/00

(52) U.S. Cl. CPC G01N 21/95607; G01N 21/8851; G06T 7/001; G06T 2207/20024; G06T 2207/30148

(57) ABSTRACT

According to one aspect of the present invention, a pattern inspection apparatus includes a parameter range setting circuit configured to set a range of a reference image generation parameter according to a coincidence degree with a past inspection condition parameter, a filter function generation circuit configured to generate a plurality of filter function candidates, using values in a set range of the reference image generation parameter, a determination circuit configured to determine a filter function for generating a reference image in the plurality of filter function candidates generated, a reference image generation circuit configured to generate a reference image by using the filter function determined, and a comparison circuit configured to compare the optical image with the reference image, wherein the reference image generation parameter is at least one of a resize amount and a corner rounding amount.

### CROSS-REFERENCE TO RELATED APPLICATION

This application is a continuation application based upon and claims the benefit of priority from prior Japanese Patent Application No. 2023-095655 (application number) filed on Jun. 9, 2023 in Japan, and International Application PCT/JP2024/017787, the International Filing Date of which is May 14, 2024. The contents described in JP2023-095655 and PCT/JP2024/017787 are incorporated herein by reference.

### BACKGROUND OF THE INVENTION

### Field of the Invention

Embodiments of the present invention relate to a pattern inspection apparatus and a pattern inspection method. For example, embodiments of the present invention relate to a pattern inspection technique for inspecting defects of patterns on an object serving as a target object or “sample” used in manufacturing semiconductor devices, and to an inspection method for inspecting defects of masks used in manufacturing semiconductor devices/elements.

### Description of Related Art

With recent progress in high integration and large capacity of the LSI (Large Scale Integrated circuits), the line width (critical dimension) necessary for circuits of semiconductor elements is further decreasing. Such semiconductor elements are manufactured through circuit forming processing by exposing and transferring a pattern onto a wafer by means of a reduced projection exposure apparatus known as a stepper, using an original or “master” pattern (also called a mask or a reticle, hereinafter generically referred to as a mask) on which a circuit pattern has been formed.

LSI manufacturing needs an enormous production cost, therefore, it is essential to improve the yield. However, as typified by 1 gigabit DRAMs (Dynamic Random Access Memories), the size of patterns that make up the LSI has been reduced to the order of nanometers from submicrons. One of major factors that decrease the yield is due to pattern defects on a mask for exposing/transferring an ultrafine pattern onto a semiconductor wafer by the photolithography technology. In recent years, with miniaturization of dimensions of LSI patterns formed on a semiconductor wafer, dimensions to be detected as a pattern defect have become extremely small. Therefore, the pattern inspection apparatus for inspecting defects of a transfer mask used in manufacturing LSI needs to be highly accurate.

As an inspection method, there is known a method of comparing an optical image obtained by imaging, using a magnification optical system, a pattern formed on a target object or “sample” such as a lithography mask at a predetermined magnification, with design data. For example, as a pattern inspection method, there is “die-to-database inspection”. The “die-to-database inspection” method inputs, into an inspection apparatus, writing data (design pattern data) generated by converting pattern-designed CAD data to a writing-apparatus-specific format to be input to the writing apparatus when a pattern is written on the mask, generates a design image (reference image) based on the input writing data, and compares the generated design image with an optical image being measurement data obtained by imaging the pattern. In that inspection method for use in the inspection apparatus, a target object is placed on the stage so that a light flux may scan the target object as the stage moves in order to perform an inspection. Specifically, the target object is irradiated with a light flux from the light source through the illumination optical system. Light transmitted through the target object or reflected therefrom forms an image on a sensor through the optical system. The image acquired by the sensor is transmitted as measurement data to the comparison circuit. After performing alignment between images, the comparison circuit compares the measurement data with reference data according to an appropriate algorithm, and determines that there is a pattern defect if the compared data do not match each other.

Since pixel data of an optical image taken from a target object is in a state affected by filtering due to resolution characteristics, etc. of the optical system used for image acquisition, in other words, in an analog state continuously changing, the optical image is different from the design image whose image intensity (gray scale value) is represented by digital values. Therefore, filter processing is performed on the design image in order to generate a reference image quality-wise close to a measurement image, and then, comparison processing is performed.

Since improvement of inspection accuracy has been needed due to recent miniaturization of pattern dimensions, it becomes necessary to enhance precision of filtering processing to improve the inspection accuracy. Thus, for improving the precision, a large number of filter functions are generated using reference image generation parameters in a wide range. Then, filter functions by which an image, quality wise, close to a measurement image can be obtained are acquired from the large number of filter functions. For generating the large number of filter functions, the throughput (processing amount) is enormous, and therefore, the time elapsed before obtaining an optimal filter function becomes long.

With regard to an inspection whose inspection conditions are similar to those of past inspections, it similarly has a problem that, since a large number of filter functions are generated, the processing amount becomes huge and the processing time elapsed before obtaining an optimal filter function takes long, which needs a long time before practically starting the inspection. Then, it is considered, when inspection conditions are the same or similar to those of past inspections, to use filter functions which were employed in the past, as they are, for the current inspection (e.g., refer to Patent Application Laid-open (JP-A) No. 2022-182497).

However, it has turned out that even if a filter function employed in a similar past inspection is used in a current inspection, a desired accuracy may not be obtained as long as the inspection conditions are not perfectly identical with each other. Meanwhile, similarly to the past case, if a large number of filter functions are generated, the problem of the processing time being long and the time elapsed before practically starting an inspection taking a long time has not yet been solved.

### BRIEF SUMMARY OF THE INVENTION

According to one aspect of the present invention, a pattern inspection apparatus includes
an optical image acquisition mechanism configured to acquire an optical image of an inspection target object on which a pattern is formed,
a parameter range setting circuit configured to set a range of a reference image generation parameter according to a coincidence degree with a past inspection condition parameter,
a filter function generation circuit configured to generate a plurality of filter function candidates, using values in a set range of the reference image generation parameter,
a determination circuit configured to determine a filter function for generating a reference image in the plurality of filter function candidates generated,
a reference image generation circuit configured to generate a reference image by using the filter function determined, and
a comparison circuit configured to compare the optical image with the reference image, wherein
the reference image generation parameter is at least one of a resize amount and a corner rounding amount.

According to another aspect of the present invention, a pattern inspection method includes
acquiring an optical image of an inspection target object on which a pattern is formed,
setting a range of a reference image generation parameter according to a coincidence degree with a past inspection condition parameter,
generating a plurality of filter function candidates, using values in a set range of the reference image generation parameter,
determining a filter function for generating a reference image in the plurality of filter function candidates generated,
generating a reference image by using the filter function determined, and
comparing the optical image with the reference image, and outputting a comparison result, wherein
the reference image generation parameter is at least one of a resize amount and a corner rounding amount.

### BRIEF DESCRIPTION OF THE DRAWINGS

FIG. 1 is a configuration diagram showing a pattern inspection apparatus according to a first embodiment;

FIG. 2 is a conceptual diagram illustrating an inspection region according to the first embodiment;

FIG. 3 is a block diagram showing an example of an internal configuration of a filter function calculation circuit according to the first embodiment;

FIG. 4 is a flowchart showing main steps of a pattern inspection method according to the first embodiment;

FIG. 5 is a chart showing an example of an inspection condition parameter and a specific gravity (weighting) of each parameter according to the first embodiment;

FIG. 6 is a chart showing an example of a relationship between a coincidence degree and a rate of narrowing down the range according to the first embodiment;

FIG. 7 is a chart showing an example of a relationship among a reference image generation parameter, a filter function, score, and a ranking, in a past inspection, according to the first embodiment;

FIG. 8 is an illustration showing an example of a reference image generation parameter range, and an example of a set range according to the first embodiment;

FIG. 9 is a flowchart showing an example of internal steps of a filter function generation step according to the first embodiment;

FIG. 10 is an illustration showing an example of a figure pattern before and after resizing according to the first embodiment;

FIG. 11 is an illustration showing an example of a figure pattern before and after rounding processing according to the first embodiment;

FIG. 12 is an illustration showing an example of a relationship among a filter function, a design image, and a measurement image according to the first embodiment;

FIG. 13 is an illustration showing an example of a method for calculating a coefficient of a filter function according to the first embodiment;

FIG. 14 is an illustration showing an example of an internal configuration of a comparison circuit according to the first embodiment; and

FIG. 15 is an illustration showing an example of a reference image generation parameter range, and an example of a set range according to a modified example of the first embodiment.

### DETAILED DESCRIPTION OF THE INVENTION

Embodiments of the present invention provide an inspection apparatus and method that can reduce the processing time elapsed before obtaining a filter function suitable for the current inspection.

Embodiments of the present invention describe a configuration using an electron beam as an example of a charged particle beam. The charged particle beam is not limited to the electron beam, and other charged particle beams such as an ion beam may also be used. Embodiments below describe a writing apparatus using multiple beams. However, it is not limited thereto, and is also preferable to employ a writing apparatus using a single beam. For example, the embodiments can be applied to a variable shaped beam (VSB) type writing apparatus.

### First Embodiment

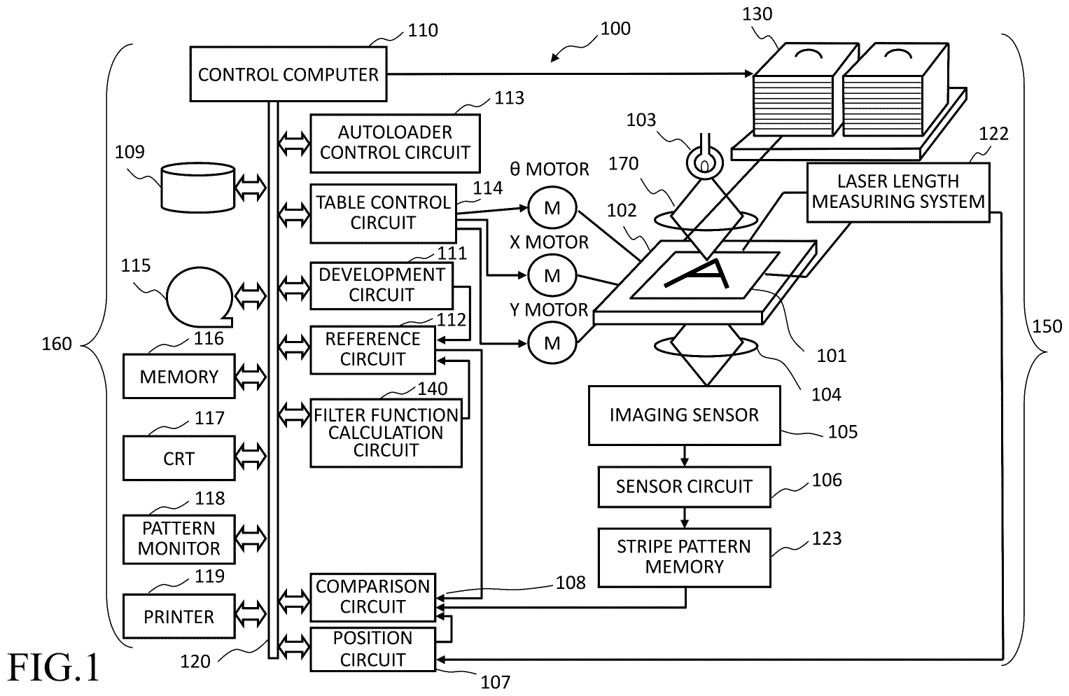

FIG. 1 is a configuration diagram showing a pattern inspection apparatus according to a first embodiment. As shown in FIG. 1, an inspection apparatus 100 that inspects defects of a pattern formed on a target object, such as a mask, includes an optical image acquisition mechanism 150 and a control system circuit 160 (control unit).

The optical image acquisition mechanism 150 includes a light source 103, an illumination optical system 170, an XYθ table 102 movably arranged, a magnifying optical system 104, an imaging sensor 105 (an example of a sensor), a sensor circuit 106, a stripe pattern memory 123, and a laser length measuring system 122. An inspection target object 101 is placed on the XYθ table 102. The inspection target object 101 is, for example, an exposure photomask used for transfer printing a pattern onto a wafer. A pattern composed of a plurality of figure patterns to be inspected is formed on the photomask. The inspection target object 101 is arranged, for example, with its pattern-forming surface facing downward, on the XYθ table 102.

As the imaging sensor 105, a line sensor or a two-dimensional sensor is used. For example, it is preferable to use a TDI (time delay integration) sensor. The TDI sensor includes a plurality of photo sensor elements arranged two-dimensionally. When an image is acquired by each photo sensor element, a predetermined image accumulation time is set. In the TDI sensor, outputs of a plurality of photo sensor elements arrayed in a scanning direction are integrated to be output. The plurality of photo sensor elements arrayed in a scanning direction acquire images of the same pixel while shifting the time according to the movement of the XYθ table 102. In the case of using a line sensor, a plurality of photo sensor elements are arranged in the direction perpendicular to the scanning direction.

In the control system circuit 160, a control computer 110 being a computer is connected, through a bus 120, to a position circuit 107, a comparison circuit 108, a development circuit 111, a reference circuit 112, an autoloader control circuit 113, a table control circuit 114, a filter function calculation circuit 140, a magnetic disk drive 109, a memory 116, a flexible disk drive (FD) 115, a CRT 117, a pattern monitor 118, and a printer 119. The sensor circuit 106 is connected to the stripe pattern memory 123 which is connected to the comparison circuit 108. The XYθ table 102 is driven by the X-, Y-, and θ-axis motors, and serves as an example of the stage.

Each “ . . . circuit”, such as the position circuit 107, the comparison circuit 108, the development circuit 111, the reference circuit 112, the autoloader control circuit 113, the table control circuit 114, and the filter function calculation circuit 140 includes processing circuitry. The processing circuitry includes, for example, an electric circuit, computer, processor, circuit board, quantum circuit, semiconductor device, or the like. The same processing circuitry (one processing circuitry), or different processing circuitry (separate processing circuitry) may be used for each “circuit”. For example, each “ . . . circuit”, such as the position circuit 107, comparison circuit 108, development circuit 111, reference circuit 112, autoloader control circuit 113, table control circuit 114, and filter function calculation circuit 140 may be configured and executed by the control computer 110. Input data necessary for the position circuit 107, comparison circuit 108, development circuit 111, reference circuit 112, autoloader control circuit 113, table control circuit 114, and filter function calculation circuit 140, and operated (calculated) results are stored in a memory (not shown) in each circuit or the memory 116 each time. Input data necessary for the control computer 110 and operated (calculated) results are stored in a memory (not shown) in the control computer 110, or the memory 116 each time. A program for causing a computer or a processor to execute processing and the like may be stored in a recording medium, such as the magnetic disk drive 109, the FD 115, the ROM (Read Only Memory), or the like.

In the inspection apparatus 100, an inspection optical system with large magnification is composed of the light source 103, XYθ table 102, illumination optical system 170, magnifying optical system 104, imaging sensor 105, and sensor circuit 106. The XYθ table 102 is driven by the table control circuit 114 under the control of the control computer 110. The XYθ table 102 can be moved by a drive system such as a three-axis (X, Y, θ) motor which drives the table in the directions of X, Y, and θ. For example, a step motor can be used as each of these X, Y, and θ motors. The XYθ table 102 is movable in the horizontal direction and the rotation direction by the X-, Y-, and θ-axis motors. The inspection target object 101 is transferred to the XYθ table 102 from the autoloader 130 controlled by the autoloader control circuit 113. The movement position of the inspection target object 101 placed on the XYθ table 102 is measured by the laser length measuring system 122, and supplied to the position circuit 107.

Writing data (design data) used as a basis for forming patterns on the inspection target object 101 is input from the outside of the inspection apparatus 100, and stored in the magnetic disk drive 109. The writing data defines a plurality of figure patterns, and each figure pattern is usually configured by combining a plurality of element figures. Such a figure pattern may be configured by one figure. Then, each pattern corresponding to and based on each figure pattern defined by the writing data is formed on the inspection target object 101.

FIG. 1 shows configuration elements necessary for describing the first embodiment. It should be understood that other configuration elements generally necessary for the inspection apparatus 100 may also be included therein.

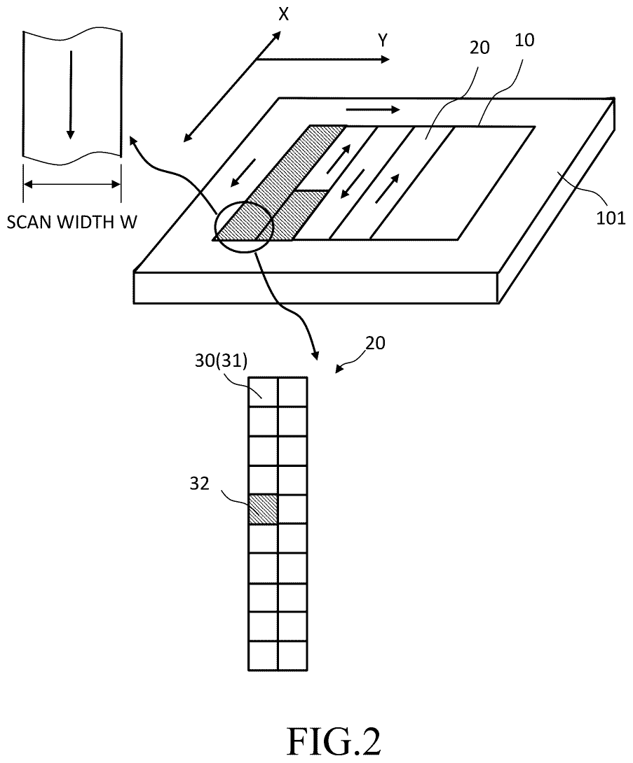

FIG. 2 is a conceptual diagram illustrating an inspection region according to the first embodiment. As shown in FIG. 2, an inspection region 10 (the entire inspection region) of the inspection target object 101 is virtually divided into a plurality of strip-shaped inspection stripes 20 each having a width W in the y direction, for example, which is the scan width of the imaging sensor 105. The inspection apparatus 100 acquires an image (stripe region image) of each inspection stripe 20. Specifically, with respect to each of the inspection stripes 20, the inspection apparatus 100 captures (acquires) an image of a figure pattern arranged in the inspection stripe 20 concerned, with a laser light (inspection light), imaging in the longitudinal direction (the x direction) of the stripe region concerned. In order to prevent a missing image, it is preferable that a plurality of inspection stripes 20 are set such that adjacent inspection stripes 20 overlap with each other by a predetermined margin width.

The imaging sensor 105 acquires an optical image while continuously moving in the x direction relatively to the movement of the XYθ table 102. The imaging sensor 105 continuously captures optical images each having the scan width W as shown in FIG. 2. According to the first embodiment, after capturing (acquiring) an optical image in one inspection stripe 20, the imaging sensor 105 moves in the y direction to the position of the next inspection stripe 20, and similarly captures another optical image having the scan width W continuously while moving in the direction reverse to the last image capturing direction. Thereby, the image capturing is repeated in the forward (FWD) and backward (BWD) directions, namely changing the direction reversely when advancing and returning.

In an actual inspection, as shown in FIG. 2, the stripe region image of each inspection stripe 20 is divided into images (frame images 31) of a plurality of rectangular (including square) frame regions 30. Then, inspection is performed for each frame image 31 of the frame region 30. For example, it is divided into the size of 512×512 pixels. Therefore, a reference image to be compared with the frame image 31 of the frame region 30 is similarly generated for each frame region 30.

The direction of image capturing is not limited to repeating the forward (FWD) and backward (BWD) movement. Images may be captured in a fixed one direction. For example, FWD and FWD may be repeated, or alternatively, BWD and BWD may be repeated.

Since pixel data of an optical image acquired from the inspection target object 101 is in a state affected by filtering due to resolution characteristics, etc. of the optical system used for image acquisition, in other words, in an analog state continuously changing, the optical image is different from the design image to be described later whose image intensity (gray scale value) is represented by digital values. Therefore, filter processing is performed on the design image to make it quality-wise close to measurement data, and then, comparison processing is performed. According to the first embodiment, in advance of executing inspection processing of the inspection target object 101, first, a filter function for performing the filter processing is calculated.

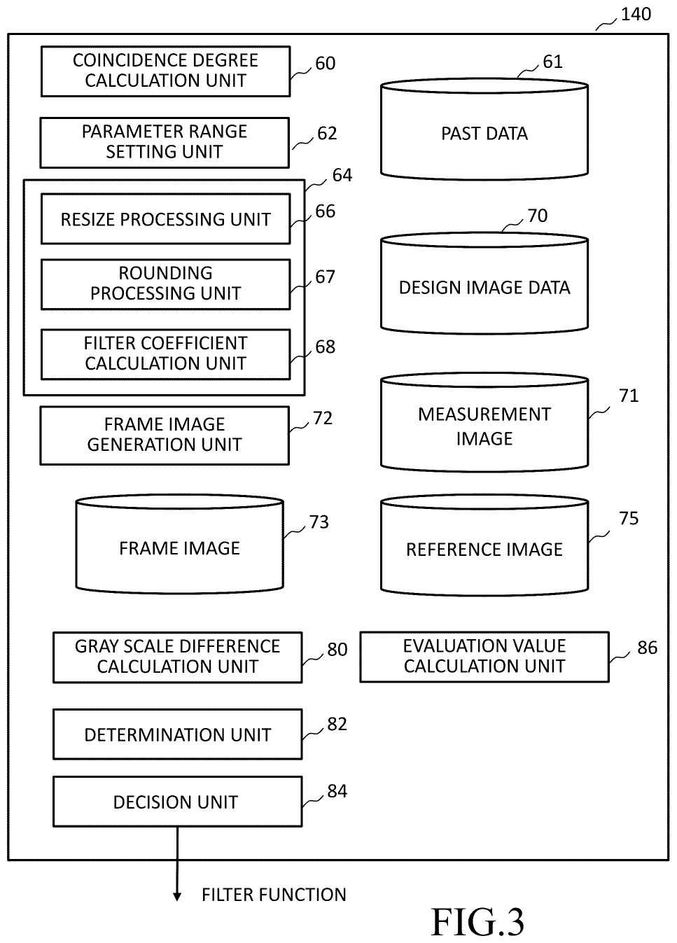

FIG. 3 is a block diagram showing an example of an internal configuration of a filter function calculation circuit according to the first embodiment. In FIG. 3, in the filter function calculation circuit 140, there are arranged storage devices 61, 70, 71, 73, and 75 such as magnetic disks, a coincidence degree calculation unit 60, a parameter range setting unit 62, a filter function generation unit 64, a frame image generation unit 72, a gray scale difference calculation unit 80, a judgment unit 82, a determination unit 84, and an evaluation value calculation unit 86. Furthermore, in the filter function generation unit 64, there are arranged a resize processing unit 66, a rounding processing unit 67, and a filter coefficient calculation unit 68.

Each “ . . . unit”, such as the coincidence degree calculation unit 60, the parameter range setting unit 62, the filter function generation unit 64 (the resize processing unit 66, the rounding processing unit 67, and the filter coefficient calculation unit 68), the frame image generation unit 72, the gray scale difference calculation unit 80, the judgment unit 82, the determination unit 84, and the evaluation value calculation unit 86 includes processing circuitry. The processing circuitry includes, for example, an electric circuit, computer, processor, circuit board, quantum circuit, semiconductor device, or the like. Each “ . . . unit” may use common processing circuitry (the same processing circuitry), or different processing circuitry (separate processing circuitry). Input data necessary for the coincidence degree calculation unit 60, parameter range setting unit 62, filter function generation unit 64 (resize processing unit 66, rounding processing unit 67, and filter coefficient calculation unit 68), frame image generation unit 72, gray scale difference calculation unit 80, judgment unit 82, determination unit 84, and evaluation value calculation unit 86, and operated (calculated) results are stored in a memory (not shown) in the filter function calculation circuit 140, or the memory 116 each time.

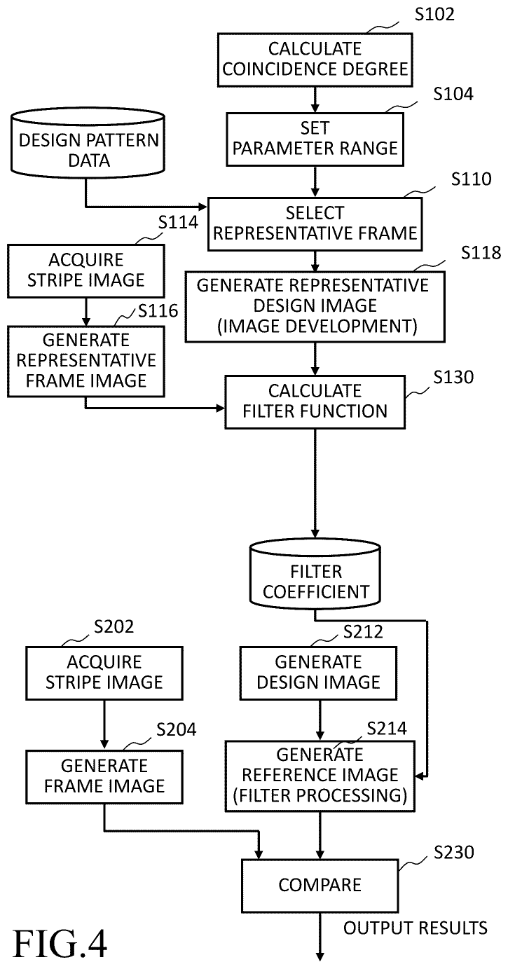

FIG. 4 is a flowchart showing main steps of a pattern inspection method according to the first embodiment. In FIG. 4, the pattern inspection method of the first embodiment performs a series of steps: a coincidence degree calculation step (S102), a parameter range setting step (S104), a representative frame selection step (S110), a stripe image acquisition step (S114), a representative frame image generation step (S116), a representative design image generation step (S118), a filter function calculation step (S130), a stripe image acquisition step (S202), a frame image generation step (S204), a design image generation step (S212), a reference image generation step (S214), and a comparison step (S230).

In the coincidence degree calculation step (S102), the coincidence degree calculation unit 60 inputs an inspection condition parameter for the inspection concerned, and calculates a coincidence degree with the inspection condition parameter used in the past.

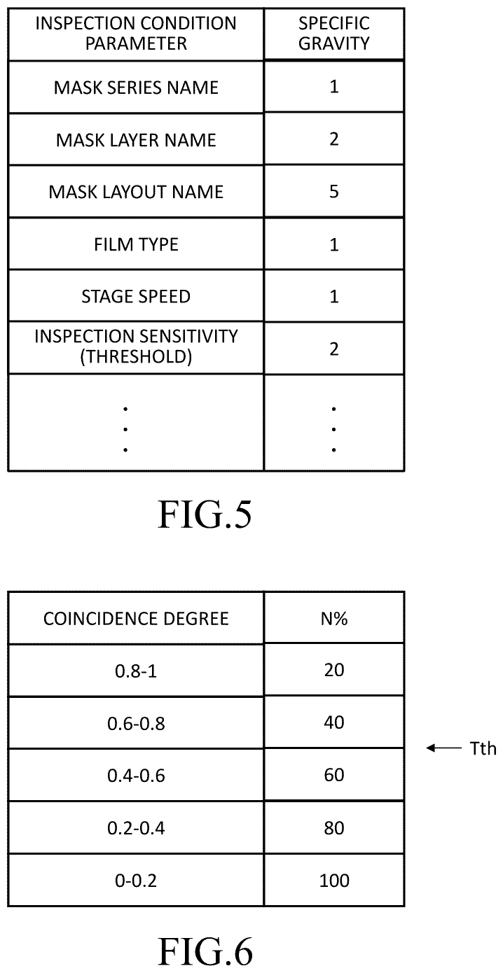

FIG. 5 is a chart showing an example of an inspection condition parameter and a specific gravity (weighting) of each parameter according to the first embodiment. In FIG. 5, as inspection condition parameters of the first embodiment, there are a pattern condition parameter and an imaging condition parameter, for example. As a parameter of pattern conditions, for example, there are shown a mask series name, a mask layer name, a mask layout name, a film type, and the like. As a parameter of imaging conditions, for example, there are shown a stage speed, inspection sensitivity(S), and the like. FIG. 5 shows the case where the specific gravity of the mask series name is 1, that of the mask layer name is 2, that of the mask layout name is 5, that of the film type is 1, that of the stage speed is 1, and that of the inspection sensitivity (threshold) is 2. Values of specific gravity (weighting) can be set based on an empirical value, etc.

Parameters of pattern conditions are defined as additional information to writing data, for example. Alternatively, it is also preferable to obtain a parameter by imaging an ID image (not shown) generated outside the inspection region 10 of the inspection target object 101. As additional information or an ID image, for example, there are defined an identification number, series name, layer name, layout name, film type, and the like of a mask used as the inspection target object 101. As a mask series name, for example, the name corresponding to the generation of a mask manufactured, such as the name indicating an advanced mask, the name of a mask with a pattern of a rough pattern size, or the like is used. As a mask layer name, for example, the name of a layer of multilayer wiring of a semiconductor device is used. As a mask layout name, for example, the name for identifying a circuit of a semiconductor device is used. As a film type, for example, the name showing a type used for pattern formation of the mask serving as the inspection target object 101 is used.

The coincidence degree calculation unit 60 calculates a coincidence degree by using at least one of a pattern condition parameter and an imaging condition parameter. Here, the case of calculating using both the parameters is described. Inspection condition parameters of the past inspections are accumulated, for each target object inspected in the past, in the storage device 61. The coincidence degree is defined by the following relational expression (1) using specific gravities of respective parameters of the inspection condition parameters.

$$Coincidence degree = ( sum of specific gravities of coincident parameters ) \text{} / ( sum of specific gravities of all parameters ) \qquad ( 1 )$$

If data of a plurality of target objects inspected in the past have been accumulated in the storage device 61, it is preferable to use the target object, from which the highest coincidence degree can be acquired, as the target object inspected in the past. Alternatively, it is sufficient to use target objects selected from the ones within the range, in the order of coincidence degree, of a predetermined number (or ratio) from the target object with the highest coincidence degree.

In the parameter range setting step (S104), in order to determine a reference image generation parameter used for reference image generation, the parameter range setting unit 62 changes/sets the range of the reference image generation parameter concerned according to the coincidence degree with past inspection condition parameters. As the reference image generation parameter, at least one of the resize amount and the corner rounding amount can be used. The range of a target reference image generation parameter is changed from the preset default range. Furthermore, the range of the target reference image generation parameter is changed to be narrower than the preset default range. Specifically, the parameter range setting unit 62 inputs an inspection condition parameter for the inspection concerned, and, according to the coincidence degree with inspection condition parameters used in the past, changes/sets a plurality of values of reference image generation parameters, which indicate at least one of the resize amount and the corner rounding amount for generating a reference image, to be in the range narrower than the preset default range of the reference image generation parameter.

FIG. 6 is a chart showing an example of a relationship between a coincidence degree and a rate of narrowing down the range according to the first embodiment. In FIG. 6, when the coincidence degree is equal to or greater than 0 (0%) and less than 0.2 (20%), 100% of the default range of the reference image generation parameter is used. When the coincidence degree is equal to or greater than 0.2 (20%) and less than 0.4 (40%), 80% of the default range of the reference image generation parameter is used. When the coincidence degree is equal to or greater than 0.4 (80%) and less than 0.6 (60%), 60% of the default range of the reference image generation parameter is used. When the coincidence degree is equal to or greater than 0.6 (80%) and less than 0.8 (80%), 40% of the default range of the reference image generation parameter is used. When the coincidence degree is equal to or greater than 0.8 (80%) and less than 1 (100%), 20% of the default range of the reference image generation parameter is used. When the coincidence degree is 1 (100%), 20% of the default range of the reference image generation parameter may be used, or the coincident past reference image generation parameter may be used. Alternatively, a preset rate within 0 to 20% of the default range of the reference image generation parameter may be used.

Alternatively, a threshold Tth for the coincidence degree can be set in advance, and then, when a calculated coincidence degree is less than the threshold Tth, the parameter range setting unit 62 may set a default range of the reference image generation parameter as the range of the reference image generation parameter. In other words, when the coincidence degree is less than the threshold Tth, it is preferable to use 100% of the default range of the reference image generation parameter. In the case of FIG. 6, for example, when the coincidence degree is less than 0.6, 100% of the default range of the reference image generation parameter is used.

With respect to the default range of the reference image generation parameter, the ratio to be used is set as described below.

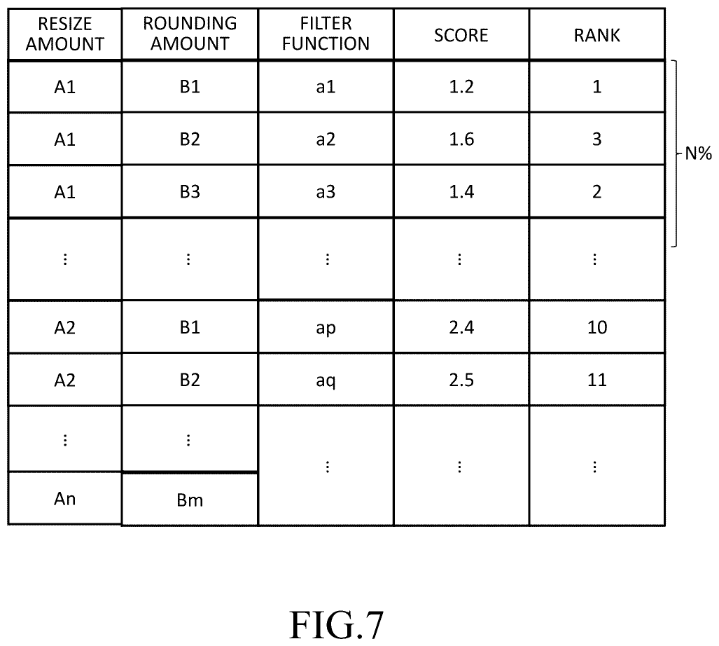

FIG. 7 is a chart showing an example of a relationship among a reference image generation parameter, a filter function, score, and a ranking, in a past inspection, according to the first embodiment. In FIG. 7, as reference image generation parameters, a resize amount and a rounding amount are used. In the example of FIG. 7, the range from A1 to An is set as the default range of the resize amount. The range from B1 to Bm is set as the default range of the rounding amount. Such ranges can be determined based on an empirical rule, etc. When calculating a filter function for reference image generation, a plurality of resize amounts A1, A2, A3, . . . , An, with a preset interval each other, within the range of the resize amount are used. Similarly, a plurality of rounding amounts B1, B2, B3, . . . , Bm, with a preset interval each other, within the range of the rounding amount are used. Then, for all the combinations each composed of one of a plurality of resize amounts A1, A2, A3, . . . . An and one of a plurality of rounding amounts B1, B2, B3, . . . . Bm, filter functions a1, a2, a3 and so on are generated. In this process, for each combination, an evaluation value of a generated filter function is calculated as a score value. It is preferable to use, as the evaluation value, for example, a sum of squares (a sum of squared differences) of the gray scale value difference, for each pixel, between a reference image generated using a generated filter function and a corresponding measurement image (optical image), or a square root of the sum of squared differences. Alternatively, it is preferable to use, as the evaluation value, for example, the maximum gray scale difference, for each pixel, between a reference image generated using a generated filter function and a corresponding measurement image (optical image). FIG. 7 shows the case of using a square root of the sum of squared differences. Then, ranking of each combination is recorded in order of score from lowest. A relation list with respect to the reference image generation parameter, filter function, score, and ranking is generated for each past inspection, and accumulated, with related to an inspection target object, as past data in the storage device 61.

In the past inspection, it was necessary, each time, to select and determine an optimal filter function from all the combinations of filter functions within the default range. Thus, for the target object inspected in the past, the preset default range of the reference image generation parameter has been used. Therefore, it is necessary to generate filter functions of multiple combinations, and much processing and time has been needed for calculation to generate a filter function for a reference image generation. Then, according to the first embodiment, not generating filter functions of all the combinations, but changing or narrowing the range of a reference image generation parameter or the number of values to be used. Concretely, with respect to at least one of the default range of the resize amount and the default range of the rounding amount, the range of a parameter value to be used is changed. Specifically, it operates as follows:

The parameter range setting unit 62 sets combinations at a rate set according to the coincidence degree, selecting combinations from higher ranking in the data of the past inspection. For example, if the coincidence degree is 0.9, the parameter range setting unit 62 extracts combinations, each composed of a resize amount and a rounding amount, which are in the narrowed range of higher ranking of 20%, and sets the extracted combinations of the resize amount and the rounding amount.

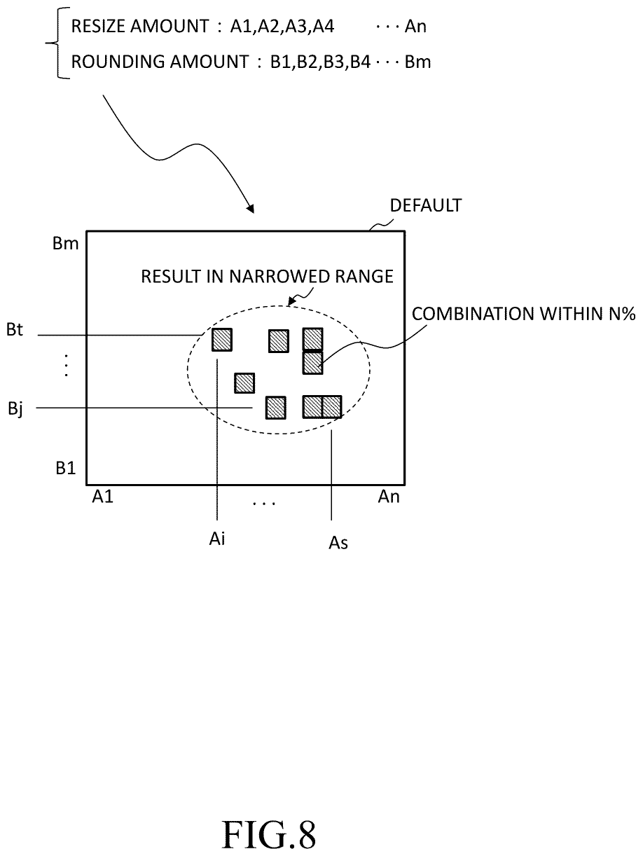

FIG. 8 is an illustration showing an example of a reference image generation parameter range, and an example of a set range according to the first embodiment. In FIG. 8, the ordinate axis represents a rounding amount, and the abscissa axis represents a resize amount. In the range from A1 to An, being the default resize amount range, there are n resize amount values. In the range from B1 to Bm, being the default rounding amount range, there are m rounding amount values. Such default ranges can be set based on an empirical rule. Accordingly, there are m×n combinations each composed of a resize amount and a rounding amount. In the m×n combinations, according to the first embodiment, N % of combinations, in order of score from lowest, are extracted depending on the coincidence degree. Thus, the number of combinations to be used for generating a filter function can be narrowed to be smaller than the number of combinations in the default range. FIG. 8 shows an example of combinations of the narrowed number.

In the representative frame selection step (S110), a representative frame to be used for calculating a filter function is selected when performing inspection of the inspection target object 101. As shown in FIG. 2, the stripe region of each inspection stripe 20 is divided into a plurality of frame regions 30, for example, and inspection is performed for each frame region 30. In other words, the inspection region 10 of the inspection target object 101 is virtually divided into a plurality of frame regions 30, and inspection is performed for each frame region 30. Here, a frame region (a representative frame 32) used for generating a filter function is selected in the inspection region 10 of the inspection target object 101. The position of the frame region (the representative frame 32) to be selected can be optionally set by the user in advance. Then, the position of the selected frame region is stored in the control computer 110. Alternatively, predetermined selection conditions may be set in advance to select the position of the frame region by the control computer 110.

In the stripe image acquisition step (S114), the optical image acquisition mechanism 150 acquires an optical image of the inspection stripe 20 including the representative frame 32 of the photomask serving as the inspection target object 101. Specifically, it operates as follows:

First, the XYθ table 102 is moved to a position where the inspection stripe 20 including the representative frame 32 can be imaged. A pattern formed on the inspection target object 101 is irradiated with a laser light (e.g., DUV light) serving as an inspection light, whose wavelength is equal to or shorter than that of a light in the ultraviolet region, from the suitable light source 103 through the illumination optical system 170. A light having passed through the inspection target object 101 is focused, via the magnifying optical system 104, to form an optical image to be incident on the imaging sensor 105 (an example of a sensor).

A pattern image focused/formed on the imaging sensor 105 is photoelectrically converted by each light-receiving element of the imaging sensor 105, and further, analog-to-digital (A/D) converted by the sensor circuit 106. Pixel data for the inspection stripe 20 to be measured is stored in the stripe pattern memory 123. Then, a stripe region image is sent to the filter function calculation circuit 140, with data indicating the position of the inspection target object 101 on the XYθ table 102 output from the position circuit 107. Measurement data (pixel data) is, for example, 8-bit unsigned data, and indicates a gray scale level of brightness (light amount) of each pixel. The stripe region image input to the filter function calculation circuit 140 is stored in the storage device 71.

In the representative frame image generation step (S116), the frame image generation unit 72 generates a frame image (representative frame image) of the representative frame 32. Concretely, the frame image generation unit 72 divides a stripe region image by a predetermined size in the x direction such that the frame image (representative frame image) of the representative frame 32 is clipped from the stripe region image (optical image) of the inspection stripe 20 including the representative frame 32. For example, it is divided into frame images each having 512×512 pixels. Data of the divided representative frame image is output to the storage device 73 to be stored therein.

In the representative design image generation step (S118), the development circuit 111 (an example of a design image generation unit) generates a design image (representative design image) by performing image development based on design pattern data being the basis for pattern formation of the inspection target object 101. Specifically, the development circuit 111 reads design data from the magnetic disk drive 109 through the control computer 110, and converts (image development) each figure pattern of the region of the representative frame 32 defined by the read design data into image data in binary or multiple values so as to generate a design image (representative design image).

Basic figures defined by the design pattern data are, for example, rectangles (including squares) and triangles. For example, figure data (vector data) which defines the shape, size, position, and the like of each pattern figure is stored by using information, such as coordinates (x, y) of the reference position of the figure, lengths of sides of the figure, and a figure code serving as an identifier for identifying the figure type such as rectangles and triangles.

When information on a design pattern used as figure data is input, the development circuit 111 develops it into data for each figure, and interprets a figure code, figure dimensions, and the like indicating the figure shape of the figure data. Then, the development circuit 111 develops the design image data in binary or multiple values as a pattern to be arranged in squares in units of grids of predetermined quantization dimensions, and outputs the developed data. In other words, the development circuit 111 reads design data, calculates the occupancy of a figure in a design pattern, for each square region obtained by virtually dividing the inspection region into squares in units of predetermined dimensions, and outputs n-bit occupancy data. For example, it is preferable to set one square as one pixel. Assuming that one pixel has a resolution of ½⁸ (= 1/256), the occupancy rate in each pixel is calculated by allocating sub-regions, each having 1/256 resolution, which correspond to the region of a figure arranged in the pixel. Then, a design image of 8-bit occupancy rate data is generated for each pixel. The data of the design image is output to the filter function calculation circuit 140, and stored in the storage device 70.

In the filter function calculation step (S130), the filter function calculation circuit 140 calculates a filter function for generating a reference image. Specifically, it operates as follows:

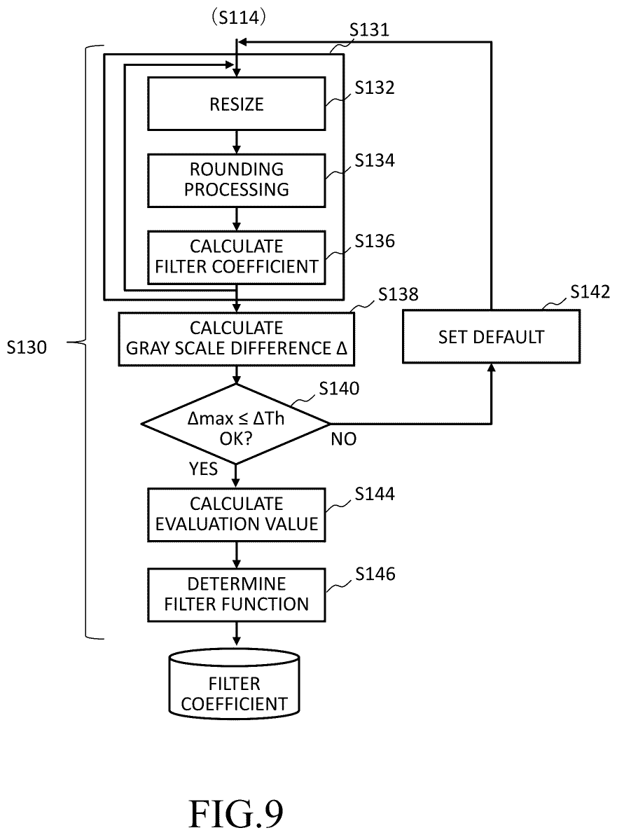

FIG. 9 is a flowchart showing an example of internal steps of a filter function generation step according to the first embodiment. In FIG. 9, the filter function calculation step (S130) performs a series of internal steps: a filter function generation step (S131), a gray scale difference calculation step (S138), a judgment step (S140), a default setting step (S142), an evaluation value calculation step (S144), and a filter function determination step (S146). The filter function generation step (S131) performs internal steps: a resizing step (S132), a rounding processing step (S134), and a filter coefficient calculation step (S136).

In the filter function generation step (S131), the filter function generation unit 64 generates a filter function for generating a reference image, using a value in the set range of a reference image generation parameter. Specifically, the filter function generation unit 64 generates a plurality of filter function candidates for generating a reference image, using each one of a plurality of values in the changed/set range or narrowed range of a reference image generation parameter. Concretely, the filter function candidate is generated for each combination in a narrowed plurality of combinations each composed of a resize amount and a rounding amount. It is more specifically described below.

First, in the resizing step (S132), the resize processing unit 66 resizes a figure pattern in the design image of the representative frame 32 by using each one of a plurality of values in the changed/set range or narrowed range of a reference image generation parameter. Concretely, a figure pattern in the design image of the representative frame 32 is resized for each combination in a narrowed plurality of combinations each composed of a resize amount and a rounding amount.

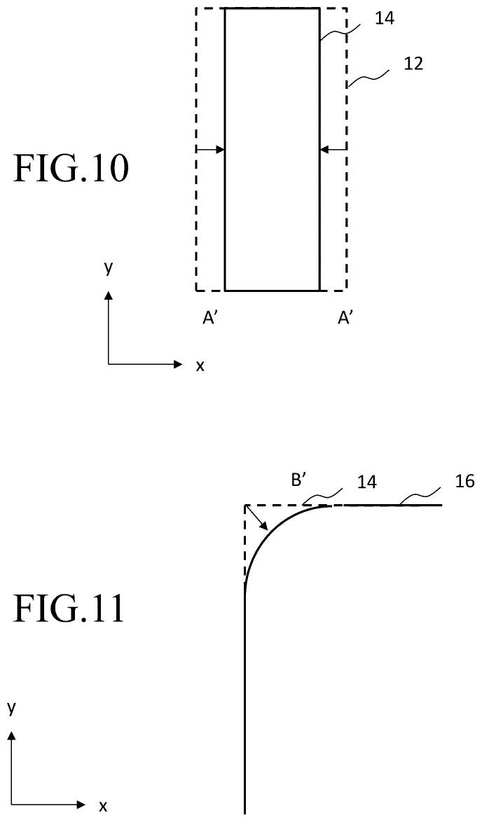

FIG. 10 is an illustration showing an example of a figure pattern before and after resizing according to the first embodiment. FIG. 10 shows a figure pattern 14 obtained by resizing the width size of a figure pattern 12 in a design image by the resize amount A′. If the default range of the resize amount is, for example, from −5 pixel to +5 pixel, it is changed/set, or narrowed to seven values (−1 pixel, −0.5 pixel, 0, +0.5 pixel, +1 pixel, +1.5 pixel, +2 pixel) at 0.5 pixel interval in the range from −1 pixel to +2 pixel, for example. A negative value indicates to resize in the direction making the width size smaller. A positive value indicates to resize in the direction making the width size larger. For example, 0.5 pixel indicates a resize amount of ½ of the pixel size. FIG. 10 shows the case of resizing the width size of the figure pattern 12 in the direction making it smaller. Although the case of resizing the x-direction width size is shown in FIG. 10, it is also preferable to resize the y-direction width size instead of the x-direction one. Alternatively, both the x-direction width size and the y-direction width size may be resized.

Next, in the rounding processing step (S134), the rounding processing unit 67 performs rounding processing on a corner portion of a figure pattern in the design image of the representative frame 32 by using each one of a plurality of values in the changed/set range or narrowed range of a reference image generation parameter. Specifically, for each combination in a narrowed plurality of combinations each composed of a resize amount and a rounding amount, rounding processing is performed on a corner portion of the figure pattern in the design image of the representative frame 32. It is preferable to perform the rounding processing on a figure pattern after resizing.

FIG. 11 is an illustration showing an example of a figure pattern before and after rounding processing according to the first embodiment. FIG. 11 shows a figure pattern 16 obtained by rounding a corner portion of the resized figure pattern 14 by a rounding amount B′. If the default range of the rounding amount is, for example, from 0 to +2 pixel, it is changed or narrowed to five values (0.2 pixel, 0.4 pixel, 0.6 pixel, 0.8 pixel, 1 pixel) at 0.2 pixel interval in the range from 0.2 pixel to 1 pixel, for example. 0.2 pixel indicates a rounding amount of ⅕ of the pixel size. The rounding amount indicates a radius of curvature. Although FIG. 11 shows the upper left corner, the rounding processing is also performed similarly on the other corners.

In the filter coefficient calculation step (S136), using each one of a plurality of values in the changed/set range or narrowed range of a reference image generation parameter, the filter coefficient calculation unit 68 calculates a coefficient of a filter function by using a design image on which resizing and/or rounding processing has been performed. Specifically, for each combination in a narrowed plurality of combinations each composed of a resize amount and a rounding amount, a coefficient of a filter function is calculated using a design image on which resizing and/or rounding processing has been performed.

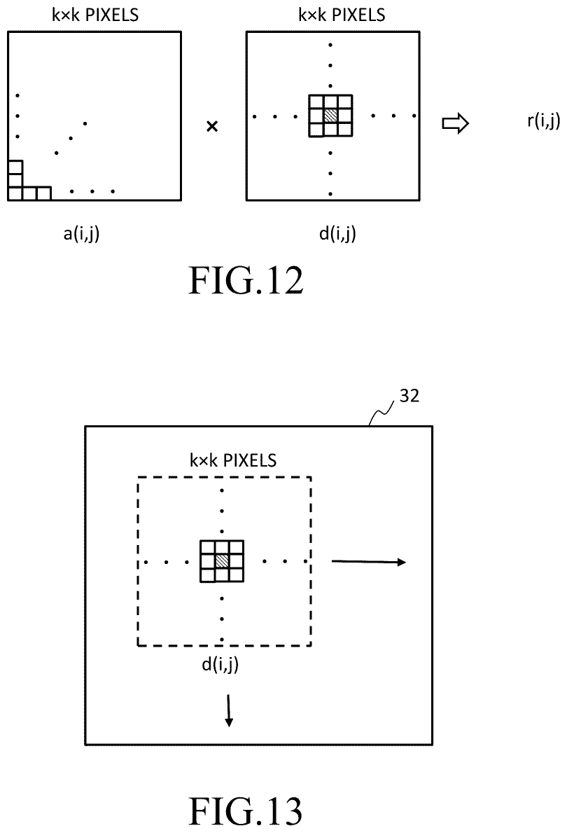

FIG. 12 is an illustration showing an example of a relationship among a filter function, a design image, and a measurement image according to the first embodiment.

FIG. 13 is an illustration showing an example of a method for calculating a coefficient of a filter function according to the first embodiment.

For example, as shown in FIG. 12, an unknown coefficient matrix a(i,j) (an example of a filter function) composed of k×k elements fewer than the number of pixels of the frame region is calculated by a method described below. For example, a coefficient matrix a(i,j) of 15×15 pixels is obtained with respect to the image of the frame region composed of 512×512 pixels. Centering a target pixel d(i,j) of the representative design image on which resizing and/or rounding processing has been performed, a coefficient matrix a(i,j) is calculated such that a value obtained by dividing a sum of products, each of which is calculated by multiplying a pixel of k×k pixels by the coefficient matrix a(i,j), by the number of pixels, N(=k×k), becomes more closer to a target pixel r(i,j) of the representative frame image corresponding to the target pixel d(i,j). A relational expression (2) concerning the above is shown below.

$$\frac{{\sum }_{i , j = - k / 2}^{k / 2} a ( i , j ) \cdot d ( i , j )}{N} = r ( i , j ) \qquad ( 2 )$$

As shown in FIG. 13, while the target pixel is shifted/moved in the representative frame region 32, the relational expression (2) is calculated each time. Then, a coefficient matrix a(i,j) is obtained which most satisfies the relational expression (2) defined using an unknown coefficient matrix a(i,j) individually calculated based on each of all the pixels in the representative frame region 32. The number of elements, k×k, of the coefficient matrix a(i,j) may be set appropriately. If the number of elements is small, the accuracy is degraded, and if too large, the operation time takes long. Furthermore, when the target pixel shifts/moves in the representative frame region 32, if the shifted position is close to an end of the frame region, there is a case where sufficient surrounding pixels do not exist at the end side around the target pixel. In such a case, calculation should be performed using surrounding pixels and the number of pixels, N, which make the calculation practical.

Based on the above, a coefficient matrix a(i,j) of a filter function is obtained for each combination in a narrowed plurality of combinations each composed of a resize amount and a rounding amount. These plurality of coefficient matrices a(i,j) are filter function candidates for generating a reference image. It is necessary to select a true filter function from these plurality of coefficient matrices a(i,j).

When the coincidence degree is less than the threshold Tth, there is a case where the parameter range setting unit 62 sets the preset default range of the reference image generation parameter as the range of the reference image generation parameter. In that case, the filter function generation unit 64 generates a plurality of filter function candidates for generating a reference image by using each one of a plurality of reference image generation parameters in the preset default range of the reference image generation parameter. Thus, when the coincidence degree is low, it is possible not to narrow down the use range of the reference image generation parameter.

In the gray scale difference calculation step (S138), first, the reference circuit 112 generates a plurality of reference image candidates by using a plurality of filter function candidates generated in the changed/set range or narrowed range of a reference image generation parameter. Specifically, it operates as follows: For each combination in a narrowed plurality of combinations each composed of a resize amount and a rounding amount, the reference circuit 112 generates a reference image candidate corresponding to the representative frame image by using a filter function candidate for the combination concerned. First, with respect to a pattern in the design image of the representative frame region 32, the reference circuit 112 performs resizing and rounding processing on the combination concerned. Then, for each pixel of the design image, centering the pixel d(i,j) concerned, the reference circuit 112 generates reference image data by dividing a sum of products, each of which is calculated by multiplying a pixel of k×k pixels by a coefficient matrix a(i,j) being a filter function for the combination concerned, by the number of pixels, N(=k×k). The obtained reference image data is sent to the filter function calculation circuit 140, and stored in the storage device 75.

Next, for each combination in a narrowed plurality of combinations each composed of a resize amount and a rounding amount, the gray scale difference calculation unit 80 calculates a gray scale difference Δ by subtracting the pixel value of the measurement image from the pixel value of the reference image. Such a gray scale difference is calculated for each pixel in the image.

In the judgment step (S140), based on the maximum gray scale difference Δmax between each reference image in a plurality of reference image candidates and a representative frame image (optical image), the judgment unit 82 judges whether there is a reference image candidate whose maximum gray scale difference Δmax is less than or equal to the threshold ΔTh in the plurality of reference image candidates. The maximum gray scale difference Δmax indicates the maximum of a plurality of gray scale differences Δ obtained with respect to all the pixels in the image concerned.

When there is no reference image candidate whose maximum gray scale difference Δmax is less than or equal to the threshold ΔTh in a plurality of reference image candidates, it proceeds to the default setting step (S142). When there is a reference image candidate whose maximum gray scale difference Δmax is less than or equal to the threshold ΔTh, it proceeds to the evaluation value calculation step (S144).

In the default setting step (S142), with respect to each of all of the plurality of reference image candidates, if the maximum gray scale difference Δmax is greater than the threshold ΔTh, the parameter range setting unit 62 performs resetting to use the default range of the reference image generation parameter. In other words, since the range of the narrowed plurality of combinations each composed of a resize amount and a rounding amount is too small, it is set to return to the default range. Thus, it returns to the filter function generation step (S131), and the filter function generation unit 64 again generates a plurality of filter function candidates for generating a reference image, by using each one of a plurality of reference image generation parameters in the default range of the reference image generation parameter. Then, the gray scale difference calculation step (S138) and the judgment step (S140) are performed.

In the evaluation value calculation step (S144), the evaluation value calculation unit 86 calculates an evaluation value of the filter function with which the reference image candidate was generated whose maximum gray scale difference Δmax is less than or equal to the threshold ΔTh. It is preferable to use, as the evaluation value, for example, the sum of squares (sum of squared differences) or the square root of the sum of squared differences of the gray scale difference in the image, using a calculated gray scale difference Δ. In the case of using the maximum gray scale difference as the evaluation value, since it has already been calculated, this step is skipped. The calculated evaluation value is recorded, as a score value described above, with a reference image generation parameter and a filter function. Then, it will be used as one of the past data in a future target object inspection.

In the filter function determination step (S146), the determination unit 84 determines a true filter function for generating a reference image in a plurality of generated filter function candidates. For example, if the number of the reference image candidates whose maximum gray scale difference Δmax is less than or equal to the threshold ΔTh is one, the filter function used for generating the reference image concerned is determined as a true filter function. For example, if the number of the reference image candidates whose maximum gray scale differences Δmax are individually less than or equal to the threshold ΔTh is two or more, it is preferable to determine the filter function used for generating a reference image whose evaluation value (for example, a square root of the sum of squared differences) obtained in the evaluation value calculation step (S144) is smaller (higher score ranking), as a true filter function.

As described above, by changing/setting or narrowing the range of a reference image generation parameter according to the coincidence degree, the throughput of filter function generation can be reduced, and therefore, the processing time can be reduced. The determined filter function (coefficient matrix) is set in the reference circuit. Similarly, the resize amount and rounding amount used for determining the filter function are set in the reference circuit. Then, inspection processing for the whole of the inspection target object 101 is started.

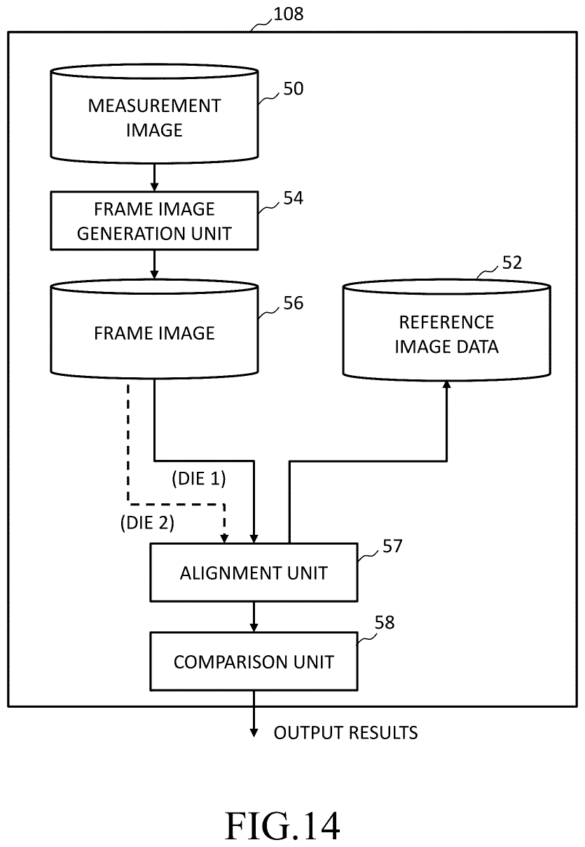

FIG. 14 is an illustration showing an example of an internal configuration of a comparison circuit according to the first embodiment. In FIG. 14, in the comparison circuit 108, there are arranged storage devices 50, 52, and 56 such as magnetic disk drives, a frame image generation unit 54, an alignment unit 57, and a comparison unit 58. Each of the “units” such as the frame image generation unit 54, the alignment unit 57, and the comparison unit 58 includes processing circuitry. The processing circuitry includes, for example, an electric circuit, computer, processor, circuit board, quantum circuit, semiconductor device, or the like. Furthermore, common processing circuitry (the same processing circuitry), or different processing circuitry (separate processing circuitry) may be used for each of the “ . . . units”. Input data needed in the frame image generation unit 54, the alignment unit 57, and the comparison unit 58, and calculated (operated) results are stored in a memory (not shown) in the comparison circuit 108 or in the memory 116 each time.

In the stripe image acquisition step (S202) (also referred to as a scanning step or an optical image acquisition step), the optical image acquisition unit 150 acquires an optical image of a photomask used as the inspection target object 101. The contents of the method of acquiring a stripe image are the same as those described above. However, here, as shown in FIG. 2, the stripe image is acquired in order. Pixel data is stored in the stripe pattern memory 123, for each inspection stripe 20. Then, the stripe region image is sent to the comparison circuit 108, with data indicating the position of the photomask 101 on the XYθ table 102 output from the position circuit 107. Measurement data (pixel data) is, for example, 8-bit unsigned data, and indicates a gray scale level of brightness (light amount) of each pixel. The stripe region image output into the comparison circuit 108 is stored in the storage device 50.

In the frame image generation step (S204), in the comparison circuit 108, the frame image generation unit 54 generates a plurality of frame images 31 by dividing the stripe region image (optical image) by a predetermined width. Specifically, as shown in FIG. 2, a stripe region image is divided into frame images of a plurality of rectangular frame regions 30. For example, it is divided into the size of 512×512 pixels. Data of each frame region 30 is stored in the storage device 56.

In the design image generation step (S212), the development circuit 111 (design image generation unit) generates a design image by performing image development based on design pattern data being a basis for forming patterns of the inspection target object 101. Specifically, the development circuit 111 reads design data from the magnetic disk drive 109 through the control computer 110, and converts each figure pattern in each frame region 30 defined by the read design data into image data in binary or multiple values. Then, a design image of 8-bit occupancy data is generated for each pixel. Data (image data) of the design image is output to the reference circuit 112.

In the reference image generation step (S214), using a determined true filter function, the reference circuit 112 (reference image generation unit) generates a reference image to be compared with an optical image. Specifically, the reference circuit 112 performs resizing and rounding processing on a design image by using the set resize amount and rounding amount, and generates a reference image by performing filtering processing using a set coefficient matrix a(i,j) (an example of a filter function). The generated reference image is output to the comparison circuit 108, and the reference image output into the comparison circuit 108 is stored in the storage device 52. Thereby, image (reference image) data of the other party to be compared for inspection is generated.

In regard to the coefficient matrix a(i,j) (an example of a filter function) calculated using the representative design image of the representative frame is used for filtering processing on all design images (a plurality of design images) of all the different frame regions 30 in the inspection region 10. In other words, a plurality of design images are individually processed by filtering using the same calculated filter function.

In the comparison step (S230), the comparison circuit 108 (an example of a comparison unit) compares an optical image with a reference image, and outputs a compared result. Specifically, it operates as follows: First, the alignment unit 57 reads a frame image (optical image) serving as a comparison target from the storage device 56, and a reference image also serving as a comparison target from the storage device 52. Alignment between the images is performed based on a predetermined algorithm. For example, the alignment is performed by the least-square method. The comparison unit 58 compares, for each pixel, both the images based on predetermined determination conditions, and determines whether there is a defect such as a shape defect or not. As the determination conditions, for example, based on a predetermined algorithm, both the images are compared with each other for each pixel to determine whether there is a defect. Then, the comparison result is output to, for example, the magnetic disk drive 109, the flexible disk drive (FD) 115, the CRT 117, or the pattern monitor 118, or alternatively, output from the printer 119.

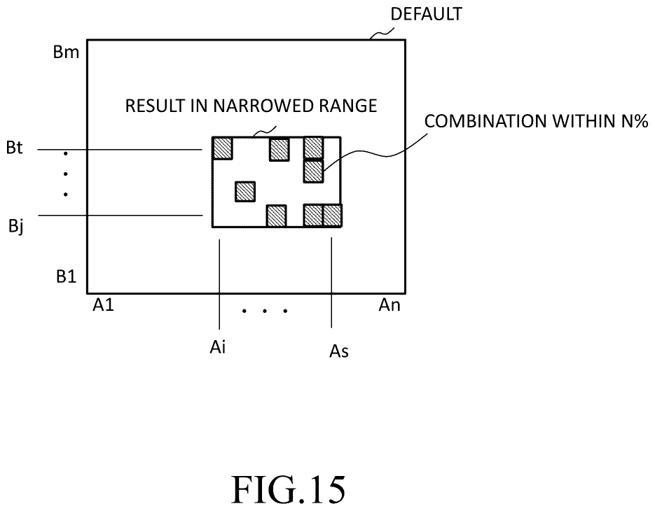

FIG. 15 is an illustration showing an example of a reference image generation parameter range, and an example of a set range according to a modified example of the first embodiment. In FIG. 15, the ordinate axis represents a rounding amount, and the abscissa axis represents a resize amount. Although FIG. 8 shows the case where a plurality of combinations in the range changed/set to No according to the coincidence degree or the range narrowed are used as they are in order of score from lowest, it is not limited thereto. It is also preferable, as shown in FIG. 15, to set a bounding rectangle of a plurality of combinations in the range changed/set to No or the range narrowed, and to treat (set) the plurality of combinations in the bounding rectangle as those in the range changed/set or narrowed. In the case of FIG. 15, the range of the resize amount is from Ai to As, and therefore, all the resize amounts, at a predetermined interval, in that range are used. The range of the rounding amount is from Bj to Bt, and therefore, all the rounding amounts, at a predetermined interval, in that range are used.

As described above, according to the first embodiment, the throughput (processing amount) before obtaining a filter function suitable for the current inspection can be reduced. Thus, the processing time elapsed before acquiring a filter function suitable for the current inspection can be reduced.

Embodiments have been explained referring to specific examples described above. However, the present invention is not limited to these specific examples. For example, in Embodiments, although a transmitted illumination optical system using a transmitted light is described as the illumination optical system 170, it is not limited thereto. For example, a reflected illumination optical system using a reflected light may also be used. Alternatively, a transmitted light and a reflected light may be used simultaneously by way of combining the transmitted illumination optical system and the reflection illumination optical system.

Furthermore, the filter function and the coefficient of the filter function described above are just examples, they are not limited thereto. Other filter function and coefficient of the filter function may also be used.

While the apparatus configuration, control method, and others not directly necessary for explaining the present invention are not described, some or all of them can be appropriately selected and used on a case-by-case basis when needed. For example, although description of the configuration of the control unit for controlling the inspection apparatus 100 is omitted, it should be understood that some or all of the configuration of the control unit can be selected and used appropriately when necessary.

Furthermore, any other pattern inspection apparatus and pattern inspection method that include elements of the present invention and that can be appropriately modified by those skilled in the art are included within the scope of the present invention.

Additional advantages and modification will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pattern inspection apparatus comprising:
an optical image acquisition mechanism configured to acquire an optical image of an inspection target object on which a pattern is formed;
a parameter range setting circuit configured to set a range of a reference image generation parameter according to a coincidence degree with a past inspection condition parameter;
a filter function generation circuit configured to generate a plurality of filter function candidates, using values in a set range of the reference image generation parameter;
a determination circuit configured to determine a filter function for generating a reference image in the plurality of filter function candidates generated;
a reference image generation circuit configured to generate a reference image by using the filter function determined; and
a comparison circuit configured to compare the optical image with the reference image, wherein
the reference image generation parameter is at least one of a resize amount and a corner rounding amount.

2. The apparatus according to claim 1, wherein
the range of the reference image generation parameter is set to be narrower than a preset default range.

3. The apparatus according to claim 1, wherein
the parameter range setting circuit sets a preset default range of the reference image generation parameter as the range of the reference image generation parameter in a case where the coincidence degree is less than a threshold value, and
the filter function generation circuit generates the plurality of filter function candidates for generating a reference image by using each one of a plurality of reference image generation parameters in the preset default range of the reference image generation parameter.

4. The apparatus according to claim 1 further comprising:
a coincidence degree calculation circuit configured to calculate the coincidence degree by using at least one of a pattern condition parameter and an imaging condition parameter.

5. The apparatus according to claim 1 further comprising:
a judgment circuit configured to judge, based on a maximum gray scale difference between an optical image and a reference image of each of a plurality of reference image candidates generated by the reference image generation circuit by using the plurality of filter function candidates generated in the set range of the reference image generation parameter, whether there is a reference image candidate whose maximum gray scale difference is one of less than and equal to a threshold value in the plurality of reference image candidates, wherein
the parameter range setting circuit performs resetting to use a preset default range of the reference image generation parameter in a case where the maximum gray scale difference is greater than the threshold value with respect to the each of all of the plurality of reference image candidates, and
the filter function generation circuit again generates a plurality of filter function candidates for generating a reference image, by using each one of a plurality of reference image generation parameters in the preset default range of the reference image generation parameter.

6. A pattern inspection method comprising:
acquiring an optical image of an inspection target object on which a pattern is formed;
setting a range of a reference image generation parameter according to a coincidence degree with a past inspection condition parameter;
generating a plurality of filter function candidates, using values in a set range of the reference image generation parameter;
determining a filter function for generating a reference image in the plurality of filter function candidates generated;
generating a reference image by using the filter function determined; and
comparing the optical image with the reference image, and outputting a comparison result, wherein
the reference image generation parameter is at least one of a resize amount and a corner rounding amount.

7. The method according to claim 6, wherein
the range of the reference image generation parameter is set to be narrower than a preset default range.

8. The method according to claim 6, wherein
a preset default range of the reference image generation parameter is set as the range of the reference image generation parameter in a case where the coincidence degree is less than a threshold value, and
the plurality of filter function candidates for generating a reference image are generated using each one of a plurality of reference image generation parameters in the preset default range of the reference image generation parameter.

9. The method according to claim 6 further comprising:
calculating the coincidence degree by using at least one of a pattern condition parameter and an imaging condition parameter.

10. The method according to claim 6 further comprising:
judging, based on a maximum gray scale difference between an optical image and a reference image of each of a plurality of reference image candidates generated by using the plurality of filter function candidates generated in the set range of the reference image generation parameter, whether there is a reference image candidate whose maximum gray scale difference is one of less than and equal to a threshold value in the plurality of reference image candidates, wherein
a preset default range of the reference image generation parameter is set to be used in a case where the maximum gray scale difference is greater than the threshold value with respect to the each of all of the plurality of reference image candidates, and
a plurality of filter function candidates for generating a reference image are again generated using each one of the plurality of reference image generation parameters in the preset default range of the reference image generation parameter.
